(19) United States
(12) Patent Application Publication
(10) Pub. No.: US 2004/0089644 A1
(43) Pub. Date: May 13, 2004

(54) Laser machining method and laser machining apparatus

(76) Inventor: Kazuma Sekiya, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/701,569

(22) Filed: Nov. 6, 2003

(30) Foreign Application Priority Data
Nov. 12, 2002 (JP) 2002 - 328068

(51) Int. Cl. B23K 26/38

(52) U.S. Cl. 219/121.72; 219/121.76

(57) ABSTRACT

A laser machining method for dividing a workpiece by shining a laser beam to the workpiece comprises: a first step of shining a first type of laser beam to a region, to be divided, of the workpiece; and a second step of shining a second type of laser beam to the region to which the first type of laser beam has been shone by the first step. A laser machining apparatus comprises a workpiece holding means for holding a workpiece, a laser beam shining means for shining a laser beam to the workpiece held by the workpiece holding means, and a moving means for moving the workpiece holding means relative to the laser beam, the laser beam shining means being capable of shining a first type of laser beam and a second type of laser beam.

### FIELD OF THE INVENTION

This invention relates to a laser machining method and a laser machining apparatus which shine a laser beam to a workpiece, such as a semiconductor wafer, along predetermined regions to divide the workpiece.

### DESCRIPTION OF THE PRIOR ART

In a semiconductor device manufacturing process, as is well known among people skilled in the art, a plurality of regions are demarcated by streets (cutting lines) arranged in a lattice pattern on the face of a nearly disk-shaped semiconductor wafer, and a circuit, such as IC or LSI, is formed in each of the demarcated regions. The semiconductor wafer is cut along the streets to divide the regions having the circuit formed thereon, thereby producing individual semiconductor chips. Cutting along the streets of the semiconductor wafer is performed normally by a cutting device called a dicer. This cutting device comprises a chuck table for holding the semiconductor wafer which is the workpiece, a cutting means for cutting the semiconductor wafer held by the chuck table, and a moving means for moving the chuck table and the cutting means relative to each other. The cutting means comprises a rotary spindle to be rotated at a high speed and a cutting blade mounted on the spindle. The cutting blade comprises a disk-shaped base and an annular cutting edge mounted on an outer peripheral portion of the side surface of the base. The cutting edge comprises diamond abrasive grains (for example, about 3 μm in particle size) fixed to a base by electroforming, and is formed with a thickness of about 20 μm. When the semiconductor wafer is cut by such a cutting blade, a fracture or crack occurs on the cut surface of the semiconductor chip cut off. Therefore, the width of the street is set at about 50 μm in consideration of the influence of the fracture or crack. If the semiconductor chip is downsized, however, the proportion of the street to the semiconductor chip increases to cause a decrease in productivity. Cutting by the cutting blade, moreover, poses problems that the feed speed is limited, and the semiconductor chips are contaminated with swarf.

In recent years, the laser machining method, in which a laser beam is shone such that it focused on the interior of the region to be divided, has been attempted as a method for dividing a workpiece such as a semiconductor wafer. This method is disclosed in Japanese Unexamined Patent Publication No. 2002-192367.

With the above-mentioned laser machining method, however, mere exposure of the workpiece to the laser beam is not sufficient to divide the workpiece, and an external force must be applied after irradiation with the laser beam in order to achieve dividing.

In recent times, the following semiconductor wafers have been put to practical use for finer fabrication of circuits such as IC and LSI: Semiconductor wafers in which a low dielectric constant insulator (Low-k film) comprising a film of an inorganic material such as SiOF or BSG (SiOB) or a film of an organic material such as a polyimide-based or parylene-based polymer film, has been laminated on the face of a semiconductor wafer body, such as a silicon wafer; and semiconductor wafers having a metal pattern called the test element group (Teg) applied thereto. However, these semiconductor wafers cannot be divided simply by exposing them to a laser beam that is shone such that it focused on the interior of the semiconductor wafer.

### SUMMARY OF THE INVENTION

The object of the present invention is to provide a laser machining method and a laser machining apparatus which can reliably divide a workpiece such as a semiconductor wafer by exposing it to a laser beam.

According to the present invention, for attaining the above object, there is provided a laser machining method for dividing a workpiece by shining a laser beam to the workpiece, comprising:

a first step of shining a first type of laser beam to a region, to be divided, of the workpiece; and

a second step of shining a second type of laser beam to the region to which the first type of laser beam has been shone by the first step.

In the above laser machining method, an output of said first type of laser beam and an output of said second type of laser beam are different from each other.

According to the present invention, there is further provided a laser machining apparatus comprising: a workpiece holding means for holding a workpiece; a laser beam shining means for shining a laser beam to the workpiece held by the workpiece holding means; and a moving means for moving the workpiece holding means relative to the laser beam, wherein the laser beam shining means has a constitution that can shine a first type of laser beam and a second type of laser beam.

The laser beam shining means desirably comprises a first laser beam shining means for shining the first type of laser beam and a second laser beam shining means for shining the second type of laser beam. The second laser beam shining means shines a laser beam having an output or a wavelength different from the output or the wavelength of the laser beam shone by the first laser beam shining means.

### BRIEF DESCRIPTION OF THE DRAWINGS

FIG. 1 is a perspective view of a laser machining apparatus constructed in accordance with the present invention.

FIG. 2 is a block diagram schematically showing the constitution of the laser beam machining means provided in the laser machining apparatus shown in FIG. 1.

FIG. 3 is an explanatory view showing the first step in a laser machining method according to the present invention.

FIG. 4 is an explanatory view showing the second step in a laser machining method according to the present invention.

### DETAILED DESCRIPTION OF THE PREFERRED EMBODIMENTS

The present invention will be described in greater detail by reference to the accompanying drawings which show the preferred embodiments of the laser machining method and the laser machining apparatus according to the present invention.

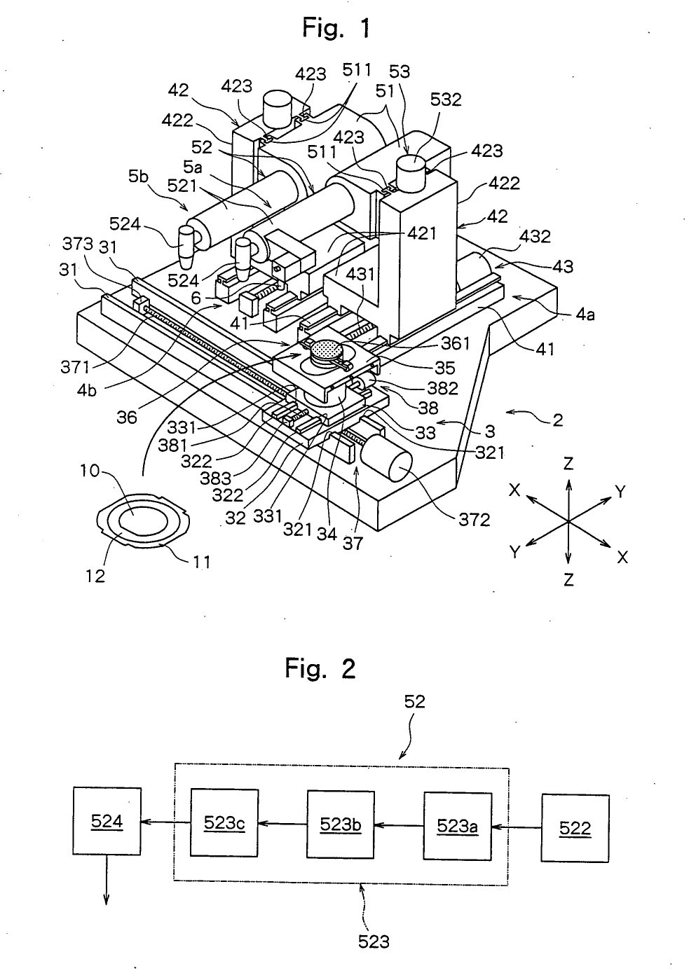

FIG. 1 shows a perspective view of a laser machining apparatus constructed in accordance with the present invention. The laser machining apparatus shown in FIG. 1 comprises a stationary base 2; a chuck table mechanism 3 that is disposed on the stationary base 2 so as to be movable in a direction indicated by arrows X and holds a workpiece; a first laser beam shining unit support mechanism 4a disposed on the stationary base 2 so as to be movable in a direction indicated by arrows Y which is perpendicular to the direction indicated by the arrows X; a first laser beam shining unit 5a disposed on the first laser beam shining unit support mechanism 4a so as to be movable in a direction indicated by arrows Z; a second laser beam shining unit support mechanism 4b; and a second laser beam shining unit 5b disposed on the second laser beam shining unit support mechanism 4b so as to be movable in the direction indicated by the arrows Z.

The chuck table mechanism 3 comprises a pair of guide rails 31, 31 disposed in parallel on the stationary base 2 along the direction indicated by the arrows X; a first slide block 32 disposed on the guide rails 31, 31 so as to be movable in the direction indicated by the arrows X; a second slide block 33 disposed on the first slide block 32 so as to be movable in the direction indicated by the arrows Y; a support table 35 supported on the second slide block 33 by a cylindrical member 34; and a chuck table 36 as a workpiece holding means. This chuck table 36 has an adsorption chuck 361 formed of a porous material, and is constituted to hold, for example, a disk-shaped semiconductor wafer, which is a workpiece, on the adsorption chuck 361 by a suction means (not shown). The chuck table 36 is rotated by a pulse motor (not shown) disposed within the cylindrical member 34.

The first slide block 32 has, on its lower surface, a pair of to-be-guided grooves 321, 321 to be fitted onto the pair of guide rails 31, 31, and has, on its upper surface, a pair of guide rails 322, 322 formed in parallel along the direction indicated by the arrows Y. The so constituted first slide block 32 has the to-be-guided grooves 321, 321 fitted onto the pair of guide rails 31, 31, whereby the first slide block 32 is movable along the pair of guide rails 31, 31 in the direction indicated by the arrows X. The chuck table mechanism 3 in the illustrated embodiment has a moving means 37 for moving the first slide block 32 along the pair of guide rails 31, 31 in the direction indicated by the arrows X. The moving means 37 comprises an externally threaded rod 371 disposed between the pair of guide rails 31 and 31 and in parallel thereto, and a drive source, such as a pulse motor 372, for rotationally driving the externally threaded rod 371. The externally threaded rod 371 is, at one end, rotatably supported by a bearing block 373 fixed to the stationary base 2, and is, at the other end, drive-transmission coupled to an output shaft of the pulse motor 372, via a reduction gear (not shown). The externally threaded rod 371 is screwed to an internally threaded through-hole formed in an internal thread block (not shown) provided projectingly on the lower surface of a central portion of the first slide block 32. Thus, the externally threaded rod 371 is driven normally and reversely rotationally by the pulse motor 372, whereby the first slide block 32 is moved along the guide rails 31, 31 in the direction of the arrows X.

The second slide block 33 has, on its lower surface, a pair of to-be-guided grooves 331, 331 to be fitted onto the pair of guide rails 322, 322 provided on the upper surface of the first slide block 32. The to-be-guided grooves 331, 331 are fitted onto the pair of guide rails 322, 322, whereby the second slide block 33 is movable in the direction indicated by the arrows Y. The chuck table mechanism 3 in the illustrated embodiment has a moving means 38 for moving the second slide block 33 along the pair of guide rails 322, 322, which are provided on the first slide block 32, in the direction indicated by the arrows Y. The moving means 38 comprises an externally threaded rod 381 disposed between the pair of guide rails 322 and 322 and in parallel thereto, and a drive source such as a pulse motor 382, for rotationally driving the externally threaded rod 381. The externally threaded rod 381 is, at one end, rotatably supported by a bearing block 383 fixed to the upper surface of the first slide block 32, and is, at the other end, drive-transmission coupled to an output shaft of the pulse motor 382, via a reduction gear (not shown). The externally threaded rod 381 is screwed to an internally threaded through-hole formed in an internal thread block (not shown) provided projectingly on the lower surface of a central portion of the second slide block 33. Thus, the externally threaded rod 381 is driven normally and reversely rotationally by the pulse motor 382, whereby the second slide block 33 is moved along the guide rails 322, 322 in the direction of the arrows Y.

The first laser beam shining unit support mechanism 4a has a pair of guide rails 41, 41 disposed in parallel on the stationary base 2 along an index feed direction indicated by the arrows Y, and a moving support base 42 disposed on the guide rails 41, 41 so as to be movable in the direction indicated by the arrows Y. The moving support base 42 comprises a moving support portion 421 disposed movably on the guide rails 41, 41, and a mounting portion 422 attached to the moving support portion 421. The mounting portion 422 has, on its side surface, a pair of guide rails 423, 423 provided in parallel and extending in the direction indicated by the arrows Z. The first laser beam shining unit support mechanism 4a in the illustrated embodiment has a moving means 43 for moving the moving support base 42 along the pair of guide rails 41, 41 in the direction indicated by the arrows Y, which is the index feed direction. The moving means 43 comprises an externally threaded rod 431 disposed between the pair of guide rails 41 and 41 and in parallel thereto, and a drive source, such as a pulse motor 432, for rotationally driving the externally threaded rod 431. The externally threaded rod 431 is, at one end, rotatably supported by a bearing block (not shown) fixed to the stationary base 2, and is, at the other end, drive-transmission coupled to an output shaft of the pulse motor 432, via a reduction gear (not shown). The externally threaded rod 431 is screwed to an internally threaded hole formed in an internal thread block (not shown) provided projectingly on the lower surface of a central portion of the moving support portion 421 which constitutes the moving support base 42. Thus, the externally threaded rod 431 is driven normally and reversely rotationally by the pulse motor 432, whereby the moving support base 42 is moved along the guide rails 41, 41 in the index feed direction indicated by the arrows Y.

The first laser beam shining unit 5a in the illustrated embodiment is equipped with a unit holder 51, and a laser beam shining means 52 attached to the unit holder 51. The unit holder 51 has a pair of to-be-guided grooves 511, 511 to be slidably fitted onto the pair of guide rails 423, 423 provided on the mounting portion 422. The to-be-guided grooves 511, 511 are fitted onto the pair of guide rails 423, 423, whereby the unit holder 51 is supported so as to be movable in the direction indicated by the arrows Z. The first laser beam shining unit 5a in the illustrated embodiment has a moving means 53 for moving the unit holder 51 along the pair of guide rails 423, 423 in the direction indicated by the arrows Z. The moving means 53, like the aforementioned respective moving means, comprises an externally threaded rod (not shown) disposed between the pair of guide rails 423 and 423, and a drive source, such as a pulse motor 532, for rotationally driving the externally threaded rod. The externally threaded rod (not shown) is driven normally and reversely rotationally by the pulse motor 532, whereby the unit holder 51 and the laser beam shining means 52 are moved along the guide rails 423, 423 in the direction indicated by the arrows Z. The laser beam shining means 52 will be described in detail later.

An imaging means 6 is disposed at a front end portion of a casing 521 constituting the laser beam shining means 52. The imaging means 6 is composed of a microscope, a CCD camera or the like for imaging the streets, etc. formed in the workpiece such as a semiconductor wafer, and sends resulting image signals to a control means (not shown).

Next, the second laser beam shining unit support mechanism 4b and the second laser beam shining unit 5b will be described. Their constituent members having substantially the same functions as those of the constituent members of the first laser beam shining unit support mechanism 4a and the first laser beam shining unit 5a will be explained using the same numerals as those of the latter constituent members.

The second laser beam shining unit support mechanism 4b is disposed in parallel to the first laser beam shining unit support mechanism 4a, and a moving support base 42 of the second laser beam shining unit support mechanism 4b is disposed opposed to the moving support base 42 of the first laser beam shining unit support mechanism 4a. Thus, the first laser beam shining unit 5a disposed on the mounting portion 422 constituting the moving support base 42 of the first laser beam shining unit support mechanism 4a, and the second laser beam shining unit 5b disposed on a mounting portion 422 constituting the moving support base 42 of the second laser beam shining unit support mechanism 4b are placed in line symmetry at close positions. No imaging means is disposed at a front end portion of a casing 521 constituting a laser beam shining means 52 of the second laser beam shining unit 5b.

The laser beam shining means 52 of the first laser beam shining unit 5a, and the laser beam shining means 52 of the second laser beam shining unit 5b will be described with reference to FIGS. 1 and 2.

The illustrated laser beam shining means 52 comprises a casing 521 of a cylindrical shape fixed to the unit holder 51 and extending substantially horizontally. Within the casing 521, a laser beam oscillation means 522 and a laser beam modulation means 523 are disposed as shown in FIG. 2. As the laser beam oscillation means 522, a YAG laser oscillator or a YVO4 laser oscillator can be used. The laser beam modulation means 523 comprises a pulse repetition frequency setting means 523a, a laser beam pulse width setting means 523b, and a laser beam wavelength setting means 523c. The pulse repetition frequency setting means 523a, laser beam pulse width setting means 523b, and laser beam wavelength setting means 523c constituting the laser beam modulation means 523 may be of forms well known among people skilled in the art and hence, detailed explanations for their constitutions are omitted herein. An optical condenser 524, which may be of a well known form per se, is mounted at the front end of the casing 521.

A laser beam oscillated by the laser beam oscillation means 522 arrives at the optical condenser 524 via the laser beam modulation means 523. In the laser beam modulation means 523, the pulse repetition frequency setting means 523a converts the laser beam into a pulse laser beam of a predetermined pulse repetition frequency, the laser beam pulse width setting means 523b sets the pulse width of the pulse laser beam at a predetermined width, and the laser beam wavelength setting means 523c sets the wavelength of the pulse laser beam at a predetermined value. The optical condenser 524 can adjust the diameter of a focusing spot.

Settings are made such that a first type of laser beam is shone by the laser beam shining means 52 of the first laser beam shining unit 5a, while a second type of laser beam is shone by the laser beam shining means 52 of the second laser beam shining unit 5b. In the illustrated embodiment, the laser beam shining means 52 of the first laser beam shining unit 5a shines a laser beam of a wavelength in the ultraviolet ray region, while the laser beam shining means 52 of the second laser beam shining unit 5b shines a laser beam of a wavelength in the infrared ray region. As factors for setting the type of laser beam, a light source, a wavelength, an output, a pulse repetition frequency, a pulse width, and the diameter of the focusing spot are enumerated. These factors are properly adjusted depending on the material of the workpiece and so on.

Next, a machining method for dividing a semiconductor wafer into individual semiconductor chips by use of the above-described laser machining apparatus will be described mainly by reference to FIGS. 1, 3 and 4.

A semiconductor wafer 10 has a back (namely, a surface opposite to a surface where circuits are formed) stuck to a protective tape 12 mounted on an annular frame 11, as shown in FIG. 1. The semiconductor wafer 10 supported on an annular frame 11 via a protective tape 12 (hereinafter simply referred to as a semiconductor wafer 10) is transported by a workpiece transport means (not shown) onto an adsorption chuck 361 of a chuck table 36 constituting the chuck table mechanism 3, and suction-held by the adsorption chuck 361. The chuck table 36, which has suction-held the semiconductor wafer 10 in this manner, is moved along the guide rails 31, 31 by the action of the moving means 37, and is positioned directly below an imaging means 6 disposed on the first laser beam shining unit 5a.

When the chuck table 36 has been positioned directly below the imaging means 6 in the above-mentioned manner, image processings such as pattern matching are carried out by the imaging means 6 and a control means (not shown) for bringing the optical condenser 524 of the first laser beam shining unit 5a that shines the first type of laser beam along the streets and the optical condenser 524 of the second laser beam shining unit 5b that shines the second type of laser beam along the streets, into alignment with the street in the first direction which is formed in the semiconductor wafer 10. Thereby, alignment of the laser beam shining position is performed. For the street in the second direction formed in the semiconductor wafer 10, alignment of the laser beam shining position is carried out similarly.

When the street formed in the semiconductor wafer 10 held on the chuck table 36 has been detected and alignment of the laser beam shining position has been performed in the foregoing manner, the chuck table 36 is moved to a laser beam shining area where the optical condenser 524 of the first laser beam shining unit 5a for shining the first type of laser beam is located. In this laser beam shining area, the first type of laser beam is shone along the street of the semiconductor wafer 10 by the optical condenser 524 of the first laser beam shining unit 5a (first step).

The first step will be described here.

In the first step, the chuck table 36, namely the semiconductor wafer 10 held thereon, is caused to move at a predetermined feed speed (for example, 100 mm/second) in the direction indicated by the arrows X, while a pulse laser beam is directed toward a predetermined street in the semiconductor wafer 10 from the optical condenser 524 of the first laser beam shining unit 5a for shining the first type of laser beam. In the first step, the following laser beam is used as the first type of laser beam:

Light source: YAG laser or YVO4 laser

Wavelength: 532 nm (ultraviolet laser beam)

Output: 6.0 W

Pulse repetition frequency: 20 kHz

Pulse width: 0.1 ns

Diameter of focusing spot: 5 μm

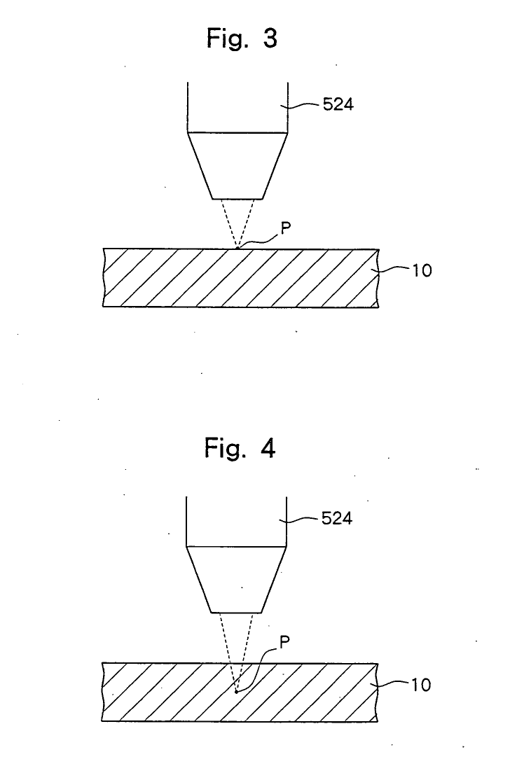

As noted above, a laser beam of a short wavelength in the ultraviolet region is used as the first type of laser beam shone in the first step, and as shown in FIG. 3, this laser beam is shone such that it has its focusing spot “P” on the face,of the semiconductor wafer 10. As a result, thermal stress is given along the street of the semiconductor wafer 10 exposed to the first type of laser beam.

Next, the chuck table 36 is moved to a laser beam shining area where the optical condenser 524 of the second laser beam shining unit 5b for shining the second type of laser beam locates. Then, the second type of laser beam is shone along the street of the semiconductor wafer 10, which has been exposed to the first type of laser beam and given thermal stress in the above first step, from the optical condenser 524 of the second laser beam shining unit 5b (second step). When the chuck table 36 is moved from the laser beam shining area where the optical condenser 524 of the first laser beam shining unit 5a locates, to the laser beam shining area where the optical condenser 524 of the second laser beam shining unit 5b locates, the moving stroke of the chuck table 36 can be shortened and hence, productivity can be increased, because in the illustrated embodiment, the first laser beam shining unit 5a and the second laser beam shining unit 5b are placed in line symmetry at close positions, so that the distance between the optical condensers 524 and 524 disposed in both units can be rendered short.

The second step will be described here.

In the second step, the chuck table 36, namely the semiconductor wafer 10 held thereon, is caused to move at a predetermined feed speed (for example, 100 mm/second) in the direction indicated by the arrows X, while a pulse laser beam is shone along a predetermined street of the semiconductor wafer 10 from the optical condenser 524 of the second laser beam shining unit 5b. In the second step, the following laser beam is used as the second type of laser beam:

Light source: YAG laser or YVO4 laser

Wavelength: 1064 nm (infrared laser beam)

Output: 5.1 W

Pulse repetition frequency: 100 kHz

Pulse width: 20 ns

Diameter of focusing spot: 1 μm

A laser beam of a long wavelength in the infrared region is used as the second type of laser beam irradiated in the above second step, and as shown in FIG. 4, this laser beam is shone such that it has its focusing spot “P” in the interior of the semiconductor wafer 10. The reason why the laser beam in the infrared region is used in the second step is that a laser beam of a short wavelength in the ultraviolet region is reflected by the surface of the semiconductor wafer 10 and does not enter the interior of the semiconductor wafer 10. The second type of laser beam has a lower output and a smaller diameter of the focusing spot than those of the first type of laser beam. By so shining the laser beam such that it has its focusing spot in the interior of the semiconductor wafer 10, thermal shock is given along the street of the semiconductor wafer 10. As a result, the semiconductor wafer 10, which has been given thermal stress upon exposure to the first type of laser beam in the first step, receives thermal shock upon exposure to the second type of laser beam in the second step, whereby the semiconductor wafer 10 is divided along the street.

After the above-described first and second steps have been carried out along all of the streets formed in the first direction of the semiconductor wafer 10, the chuck table 36 is turned 90 degrees. Then, the above-described first and second steps are carried out along all of the streets formed in the second direction of the semiconductor wafer 10. By this procedure, the semiconductor wafer 10 is divided into individual semiconductor chips.

The above-described embodiment presents an example in which after the first step is carried out for a single street, the second step is immediately carried out for the street. However, the first step may be carried out for all the streets formed in the semiconductor wafer 10 and then, the second step may be carried out for all of the streets.

Next, an explanation will be offered for an example of dividing a semiconductor wafer having a low dielectric constant insulator (Low-k film) laminated on the face of a semiconductor wafer body comprising a silicon wafer.

In this case, the first step is carried out in the following manner: The first type of laser beam is shone along the street by the optical condenser 524 of the first laser beam shining unit 5a such that it has its focusing spot on the low dielectric constant insulator (Low-k film) formed on the face of the semiconductor wafer body. As a result, the low dielectric constant insulator (Low-k film) formed on the face of the semiconductor wafer body is removed and concurrently, thermal stress is given along the street of the semiconductor wafer.

In this first step, the following laser beam is used:

Light source: YAG laser or YVO4 laser

Wavelength: 355 nm (ultraviolet laser beam)

Output: 3.0 W

Pulse repetition frequency: 20 kHz

Pulse width: 0.1 ns

Diameter of focusing spot: 5 μm

In this embodiment, a laser beam of a shorter wavelength in the ultraviolet region than the laser beam in the aforementioned embodiments is used as the laser beam in the present embodiment. However, the laser beam of the same wavelength as in the aforementioned embodiments may be used. The output of the laser beam in the present embodiment is lower than in the aforementioned embodiments.

By performing the first step in the above-described manner, the low dielectric constant insulator (Low-k film) is removed and concurrently, thermal stress is given along the street of the semiconductor wafer. Then, like the second step in the aforementioned embodiment, the second type of laser beam (laser beam in the infrared region) is shone along the street of the semiconductor wafer, which has been rid of the low dielectric constant insulator (Low-k film) and given thermal stress, such that it has its focusing spot in the interior of the semiconductor wafer, from the optical condenser 524 of the second laser beam shining unit 5b. The second type of laser beam in the second step may be as follows similarly to the aforementioned embodiment:

Light source: YAG laser or YVO4 laser

Wavelength: 1064 nm (infrared laser beam)

Output: 5.1 W

Pulse repetition frequency: 100 kHz

Pulse width: 20 ns

Diameter of focusing spot: 1 μm

As described above, the second type of laser beam is shone along the street of the semiconductor wafer, which has been rid of the low dielectric constant insulator (Low-k film) and given thermal stress in the first step, to give thermal shock, whereby the semiconductor wafer is divided along the street.

Dividing of a semiconductor wafer provided with a metal pattern called the test element group (Teg) can be also performed by the same method as the above-mentioned method of dividing a semiconductor wafer having a low dielectric constant insulator (Low-k film) formed on the face of a semiconductor wafer body. That is, in the first step, the first type of laser beam (laser beam in the ultraviolet region) is,applied to a division area where a metal member is formed, such that it has its focusing spot on the surface of the semiconductor wafer. By this treatment, the metal member is removed and concurrently, thermal stress is given along the street of the semiconductor wafer. Then, the second type of laser beam (laser beam in the infrared region) is shone along the street of the semiconductor wafer, which has been rid of the metal member and given thermal stress in the first step, to cause thermal shock, whereby the semiconductor wafer is divided along the street.

The present invention has been described as above based on the embodiments, but the invention is not limited to the embodiments, and various changes and modifications may be made within the range of the technical ideas of the present invention. That is, the above embodiments present examples in which the first type of laser beam and the second type of laser beam are different in output and wavelength. However, a laser beam of the same wavelength and with different outputs can be used as the first type of laser beam and the second type of laser beam. For example, in the first step, a laser beam having a low output and belonging to the infrared region (the first type of laser beam) is shone along the street of a semiconductor wafer to form a guide line. In the second step, a high output laser beam in the infrared region having the same wavelength as the wavelength of the first type of laser beam (i.e. the second type of laser beam) is shone along the street of the semiconductor wafer, whereby the laser beam is guided by the guide line and the semiconductor wafer is divided according to the guide line. After the first and second steps are performed, a predetermined laser beam may further be shone to divide the workpiece.

In the illustrated embodiments described above, when the first and second steps are performed, the semiconductor wafer 10 held by the chuck table 36 is moved. However, the first laser beam shining unit 5a and the second laser beam shining unit 5b may be moved. The illustrated embodiments also present the example in which the semiconductor wafer 10 held by the chuck table 36 is moved for indexing in the direction of the arrows Y. However, the first laser beam shining unit 5a and the second laser beam shining unit 5b may be moved for indexing in the direction of the arrows Y. In moving the first laser beam shining unit 5a and the second laser beam shining unit 5b, however, accuracy is likely to deteriorate owing to vibrations, etc. Theregfore it is preferred to keep the first laser beam shining unit 5a and the second laser beam shining unit 5b stationary and, instead, move the chuck table 36, namely the semiconductor wafer 10 held thereon, appropriately.

According to the laser machining method of the present invention, a workpiece can be reliably divided by exposing regions of the workpiece to be divided to the first type of laser beam, and then, applying the second type of laser beam thereto.

According to the laser machining apparatus of the present invention, the laser beam shining means is constituted to be able to shine the first type of laser beam and the second type of laser beam. Thus, the workpiece can be divided efficiently by a single laser machining apparatus.

What I claim is:

1. A laser machining method for dividing a workpiece by shining a laser beam to the workpiece, comprising:
a first step of shining a first type of laser beam to a region, to be divided, of the workpiece; and
a second step of shining a second type of laser beam to the region to which said first type of laser beam has been shone by said first step.

2. The laser machining method according to claim 1, wherein an output of said first type of laser beam and an output of said second type of laser beam are different from each other.

3. The laser machining method according to claim 1, wherein a wavelength of said first type of laser beam and a wavelength of said second type of laser beam are different from each other.

4. A laser machining apparatus comprising:
a workpiece holding means for holding a workpiece;
a laser beam shining means for shining a laser beam to the workpiece held by said workpiece holding means; and
a moving means for moving said workpiece holding means relative to the laser beam, wherein
said laser beam shining means has a constitution capable of shining a first type of laser beam and a second type of laser beam.

5. The laser machining apparatus according to claim 4, wherein said laser beam shining means comprises a first laser beam shining means for shining said first type of laser beam, and a second laser beam shining means for shining said second type of laser beam.

6. The laser machining apparatus according to claim 5, wherein said second laser beam shining means shines a laser beam having an output or a wavelength different from an output or a wavelength of the laser beam shone by said first laser beam shining means.
